(19) United States
(12) Patent Application Publication
(10) Pub. No.: US 2020/0413267 A1
(43) Pub. Date: Dec. 31, 2020

(54) UE MODEM FOR DRONES WITH FLIGHT PATH AND 3D WIRELESS ENVIRONMENT SIGNAL QUALITY INFORMATION

(71) Applicant: Apple Inc., Cupertino, CA (US)

(72) Inventors: Feng Xue, Redwood City, CA (US); Shu-ping Yeh, Campbell, CA (US); Philippe Auzas, Portland, OR (US); Mengkun Ke, Beaverton, OR (US); Ranganadh Karella, San Diego, CA (US); Jingwen Bai, San Jose, CA (US)

(21) Appl. No.: 16/457,729

(22) Filed: Jun. 28, 2019

(51) Int. Cl. H04W 16/26; H04W 76/28; H04W 24/08; H04B 7/185; B64C 39/02

(52) U.S. Cl. CPC H04W 16/26; H04W 76/28; B64C 39/024; H04B 7/18504; H04W 24/08

(57) ABSTRACT

Systems and methods of controlling drones are disclosed. Computation and control of beam direction and frequency is dependent on drone characteristics including three-dimensional location, orientation, and flight plan, with messages exchanged between the drone processor and modem dependent on which entity is performing the computation and control. Communications with the serving cell use a directional antenna and cell selection using an omni-directional antenna. MDT measurement and reporting and IDC measurement uses the drone characteristics and battery life.

### TECHNICAL FIELD

Aspects pertain to radio access networks (RANs). Some aspects relate to cellular networks, including Third Generation Partnership Project Long Term Evolution (3GPP LTE) networks and LTE advanced (LTE-A) networks, 4^{th} generation (4G) networks and 5^{th} generation (5G) New Radio (NR) (or next generation (NG)) networks. Some aspects relate to communication techniques used to enhance communications between terrestrial systems and a user equipment (UE) at an elevated altitude.

### BACKGROUND

The use of various types of user equipment (UEs) using network resources continues to increase, as does amount of data and bandwidth being used by various applications, such as video streaming, operating on these UEs. Among the UEs, mobile devices operating at elevated altitudes and moving substantial distances is becoming increasingly common. The popularity of drones, for example, has exploded in the past several years, and low-altitude personal transportation devices are likely to be developed and used in the near future. The issues involving communications of the UEs with base stations (BSs) (also referred to as RANs), which are set up primarily for communication with ground-level UEs, coupled with the introduction of a complex new communication system engenders a large number of issues to be addressed both in the system itself and in compatibility with previous systems and devices, including those of modem performance.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 is a functional block diagram illustrating a system according to some aspects,

FIG. 2 illustrates a block diagram of a communication device in accordance with some aspects;

FIG. 3 illustrates high level architecture of a communication device in accordance with some aspects;

FIG. 4 illustrates high level architecture of a communication device with beam/frequency selection in accordance with some aspects;

FIG. 5 illustrates high level architecture of another communication device with beam/frequency selection in accordance with some aspects;

FIG. 6 illustrates high level architecture of another communication device with beam/frequency selection in accordance with some aspects;

FIGS. 7A and 7B respectively illustrate a flight path and link quality of different base stations in accordance with some aspects;

FIGS. 8A and 8B respectively illustrate the handover failure rate for urban macro-cell (UMA) and rural macro-cell (RMA) in accordance with some aspects:

FIG. 9 illustrates a measurement model for omni-directional antenna measurement in accordance with some aspects:

FIG. 10 illustrates a measurement model for switching between omni- and directional antenna measurements in accordance with some aspects;

FIG. 11 illustrates replacing a wireless environment database using an omni-directional antenna measurement estimation in accordance with some aspects:

FIG. 12 illustrates converting a directional antenna measurement to an omni-directional antenna measurement in accordance with some aspects;

FIG. 13 illustrates converting a directional antenna measurement to an omni-directional antenna measurement in accordance with some aspects;

FIG. 14 illustrates UE antenna beam index mapping in accordance with some aspects;

FIG. 15 illustrates determining the serving beam direction in accordance with some aspects;

FIG. 16 illustrates angular change of the best serving beam in accordance with some aspects;

FIG. 17A illustrates elevation change as a function of time in accordance with some aspects; FIG. 17B illustrates a priority list change in accordance with some aspects;

FIG. 18 illustrates another priority list change in accordance with some aspects;

FIG. 19 illustrates a timing configuration computation in accordance with some aspects; and

FIG. 20 illustrates power-aware Minimization of Drive Test (MDT) reporting in accordance with some aspects.

### DETAILED DESCRIPTION

The following description and the drawings sufficiently illustrate specific aspects to enable those skilled in the art to practice them other aspects may incorporate structural, logical, electrical, process, and other changes. Portions and features of some aspects may be included in, or substituted for, those of other aspects. Aspects set forth in the claims encompass all available equivalents of those claims.

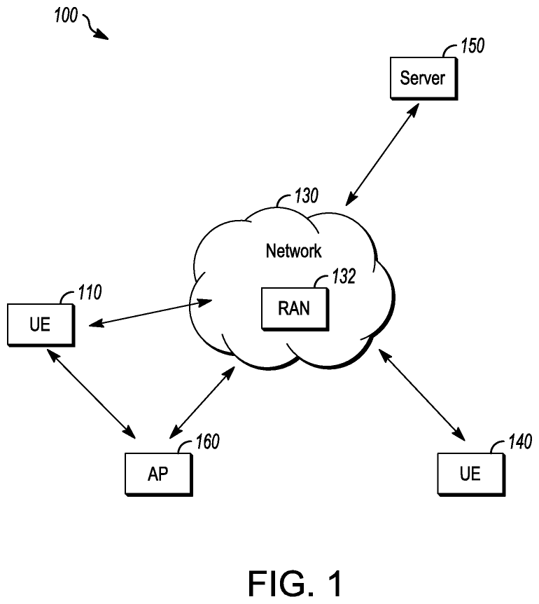

FIG. 1 is a functional block diagram illustrating a system according to some aspects. The system 100 may include multiple UEs 110, 140. In some aspects, one or both the UEs 110, 140 may be communication devices that communicate with each other directly (e.g., via P2P or other short range communication protocol) or via one or more short range or long range wireless networks 130. The UEs 110, 140 may, for example, communicate wirelessly locally, for example, via one or more BSs 132 (also called BS nodes), WiFi access points (APs) 160 or directly using any of a number of different techniques, such as WiFi, Bluetooth or Zigbee, among others. The BS 132 may contain one or more micro, pico or nano base stations. The BS 132 may be, for example, evolved NodeBs (eNBs) or next (5^{th}) generation NodeBs (gNBs).

The UEs 110, 140 may also communicate through the network 130 via Third Generation Partnership Project Long Term Evolution (3GPP LTE) protocols and LTE advanced (LTE-A) protocols, 4G protocols or NR protocols. Examples of UEs 110, 140 include, but are not limited to, mobile devices such as portable handsets, smartphones, tablet computers, laptop computers, wearable devices, sensors and devices in vehicles, such as cars, trucks or aerial devices (drones). The UEs 110, 140 may communicate with each other and/or with one or more servers 150. The particular server(s) 150 may depend on the application used by the UEs 110, 140.

The network 130 may contain network devices such as an access point for WiFi networks, a base station (which may be e.g., an eNB or gNB), gateway (e.g., a serving gateway and/or packet data network gateway), a Home Subscriber Server (HSS), a Mobility Management Entity (MME) for LTE networks or an Access and Mobility Function (AMF), etc., for NG networks. The network 130 may also contain various servers that provide content or other information related to user accounts.

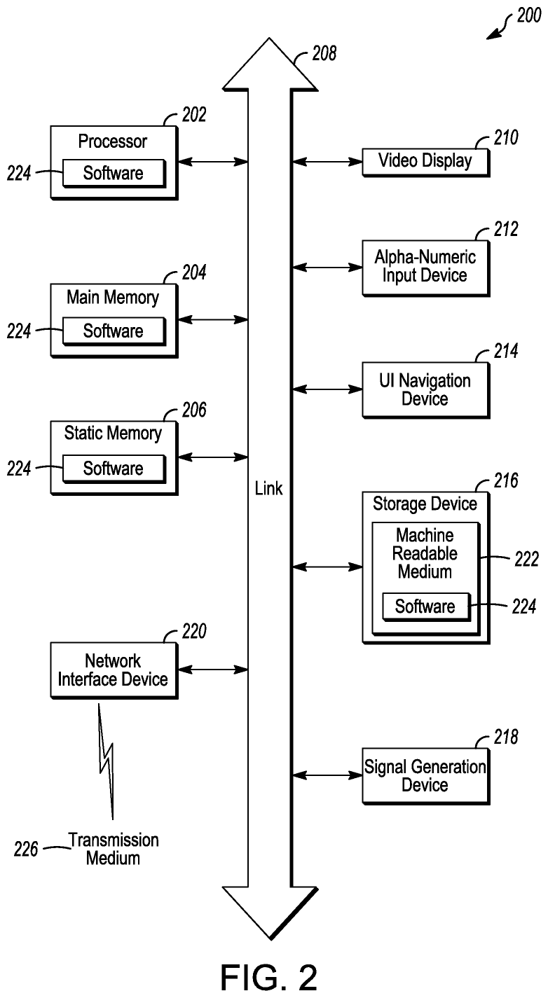

FIG. 2 illustrates a block diagram of a communication device in accordance with some aspects. Some of the elements shown in FIG. 2 may not be present depending on the type of the device. In some aspects, the communication device 200 may be a UE such as an unmanned aerial device (UED or drone), a specialized computer, a personal or laptop computer (PC), a tablet PC, a personal digital assistant (PDA), a mobile telephone, a smart phone, a web appliance (e.g., camera, doorbell, security apparatus), or other user-operated communication device. In some aspects, the communication device 200 may be a UE embedded within another, non-communication based device such as a vehicle (e.g., car) or home appliance (e.g., refrigerator). In some aspects, the communication device 200 may be a network-operated device, such as an AP, an eNB, a gNB, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

As above, autonomous UEs used at elevated locations (of over about 100 m above ground level) have rapidly increased in popularity over the last decade or so. The autonomous aerial UEs may include unmanned aerial vehicles (UAVs), also known as drones. The increased use of such UEs may, however, engender issues that, among others, both relate to network communications and governmental regulations. For example, issues with communications between the drones and terrestrial systems, which are typically designed for communication with ground-level devices, may include safety and reliability of drone operation beyond visual line-of-sight (LoS) range, as well as delivering data generated by new drone applications.

In particular, the special characteristics of aerial channels, such as higher LoS probability, less propagation attenuation compared to terrestrial channel and less shadowing (large scale fading over at least several meters due to obstacles) variation, cast unique design challenges for UE modems on drones. In some cases, the drone trajectory may be preconfigured and may only drift slightly from the predetermined route. Combined with the fact that aerial channels are more predictable in terms of fading and multipath loss as there are fewer obstacles in the sky, wireless transmission performance can be enhanced with the knowledge of the drone flight path and some estimate of the wireless signal environment.

3GPP release 15 has already approved the reporting of flight path information by aerial UEs to the network, thereby permitting a base station or network server to configure network setting to best serve aerial UEs and minimize interference impact from aerial UEs. In addition to changes to interactions between the aerial UE and the network, improvements within the aerial UE are desirable. For example, interactions between the UE modem with application processors and onboard sensors of the UE may be improved to enhance communication performance based on flight path information. To this end, control architectures, control signaling flows and methods to enhance drone UE modem performance through the architecture and signaling are disclosed.

In particular, UE modems presently operate according to standard protocols with network-configured operation parameters without utilizing any route information. Moreover, route characteristics for non-aerial (terrestrial) UEs may be limited; that is, scenarios such as terrestrial vehicle communication given layout of roads and highways may be inapplicable for aerial UEs. For communication with terrestrial UEs, some level of uncertainty due to moving obstacles, unpredictable maneuver and change of direction at intersections may be assumed. Design of communication support for drones, on the other hand, may be adjusted from terrestrial UE communication support as drone trajectory may be predetermined before flight. Notably, during the flight, a drone may receive a trajectory update only infrequently, if at all, from the drone controller. In addition, unlike terrestrial UEs, although drones may experience uncontrollable aerial-related conditions such as wind, such conditions may typically result in only a minor deviation (e.g., a few feet) from the prearranged route.

Thus, compared to terrestrial UE vehicular communications, communication with drones can assume more detail knowledge of the travel path given the fact that most drone applications use a preprogrammed trajectory. Accordingly, as the unexpected deviation of a drone from the desired route may be minor, the use of route information to enhance cellular modem may result in modem operation being more efficient and less power hungry. Route information can be used, for example, to reduce scanning and measurement time during the paging cycle and improve idle mode power efficiency. Such information may be used, in addition, to control directional antennas at the drone UE. Note that similar uses can also be applied to integrated on-vehicle modems with full access to navigation and vehicle control information. To this end, control architectures to incorporate flight path information and one or more estimates of wireless environment for monitoring and managing frequency and beam-direction selection.

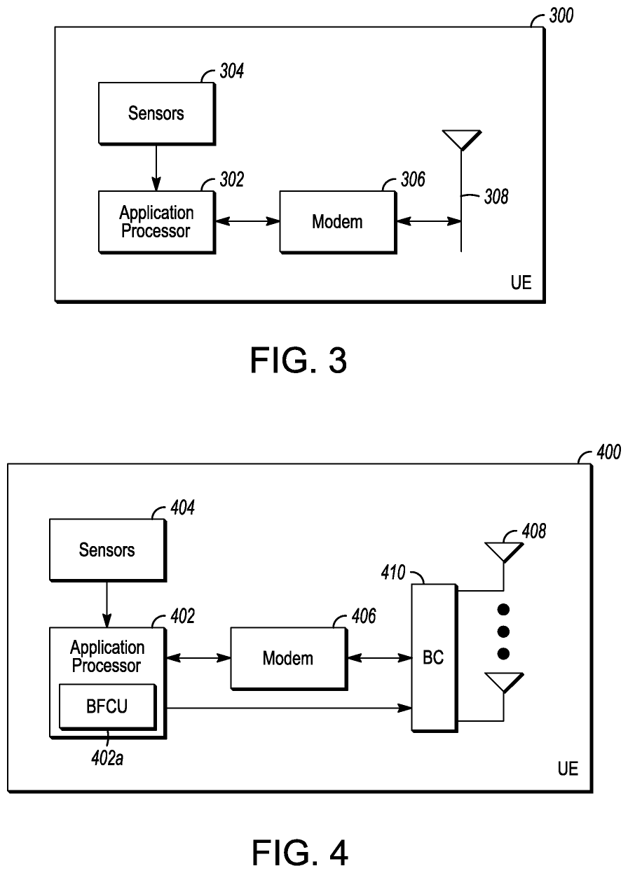

FIG. 3 illustrates high level architecture of a communication device in accordance with some aspects. The communication device 300 may be, as above, a drone or other vehicular-based UE. The communication device 300 may include an application processor 302 that is configured to generate data and control signals for transmission to the network and other components of the UE and receive data and control signals from the same. Communications with the network may be received and transmitted by one or more antennas 308. The antennas 308 may be omni-directional or directional and, in some cases may be controlled by the application processor 302 to provide beamforming. Note that throughout the description, transmission of the various signals may include generation and encoding of the signals from the transmitting device and reception of the various signals may include decoding and storage of the received signals.

In particular, control messages may be exchanged between the application processor 302 and the wireless modem 306. A memory of the drone may store information, including the drone flight path information (e.g., the 3D flight path of the drone), maps of nearby base stations and their antenna and/or power configurations, a preference list of nearby base stations and an estimate of the wireless environment. The information may be either preloaded before the mission or occasionally updated by the remote drone operator or other sources (such as automatically by the network or via other drones). The stored information may be used by the application processor 302 for communication with the wireless modem 306.

In addition to the wireless modem 306 and application processor 302, additional information may be available from sensor measurements conducted by one or more sensors 304. The sensors 304 may include one or more of: a positional sensor, such as a GPS sensor, or other sensors that are capable of detecting orientation of the communication device 300. These other sensors may include, but are not limited to, one or more inertial measurement units (IMUs), accelerometers, magnetometers, gyroscopes, etc.

To compute and control the beam direction and carrier frequency, the application processor 302 and modem 306 may exchange multiple pieces of information. In general, the modem 306 may provide connection status information to the application processor 302, including current serving cell identification (ID), an indication of radio resource control (RRC) connection status of the device 300 with the RAN (e.g., eNB, gNB), an indication of transmission of a measurement report (such as a channel state information measurement report), an indication of reception of a Handover Message from the RAN, or the timing to switch to a new serving cell and the new serving cell ID. The modem 306 may also provide to the application processor 302 one or more measurements of wireless link quality, including a (OSI model) layer 1 (L1) or layer 3 (L3) reference signal received power (RSRP) of the serving cell and one or more top interfering cells, an L1 or L3 layer reference signal received quality (RSRQ) of these cells, or an indication of physical layer out-of-sync detection. The modem 306 may also provide to the application processor 302 with timing and other information for monitoring different frequency bands or beam directions, including one or more of: settings of the measurement gap, the paging cycle, idle-mode discontinuous reception (DRX) parameters, connected-mode DRX (C-DRX) parameters, measurement configurations and a list of neighbor cells to monitor as recommended by the eNB/gNB.

Similarly, the application processor 302 may provide other information to the modem 306. This information may include location and other movement information, such as the flight plan or other route information. The application processor 302 may also provide to the modem 306 an estimation of one or more of: the current and/or near-future 3D position, velocity and orientation of the communication device 300 based on sensor measurement and robotic control status. The application processor 302 may calculate the positional/movement information from the information supplied by the sensors 304. The application processor 302 may also provide to the modem 306 environment information such as eNB/gNB locations and antenna patterns. In some cases, the application processor 302 may estimate or otherwise determine the wireless link quality along the flight path, which may then be provided to the modem 306. The wireless link quality along the flight path may be estimated by the application processor 302 using, for example, the L3 RSRP measurements with one or more omni-directional antennas based on mapping information, using past measurements and/or using data from a database of eNB/gNB settings and locations. In addition to positional information, the application processor 302 may also provide to the modem 306 a recommended priority list of beam direction and carrier frequency. Note that some of the messages provided from the application processor 302 to the modem 306 may be used to support the 3GPP Release 15 report of 3D position, velocity and flight-path. Others of the messages may be useful to achieve efficient frequency/beam monitoring to save power and improve performance.

In some embodiments, the application processor 302 may have access to a database containing the preferred beam directions and frequency band information when connecting to different base stations. In some embodiments, the database can simply be a geographical map of the base station locations.

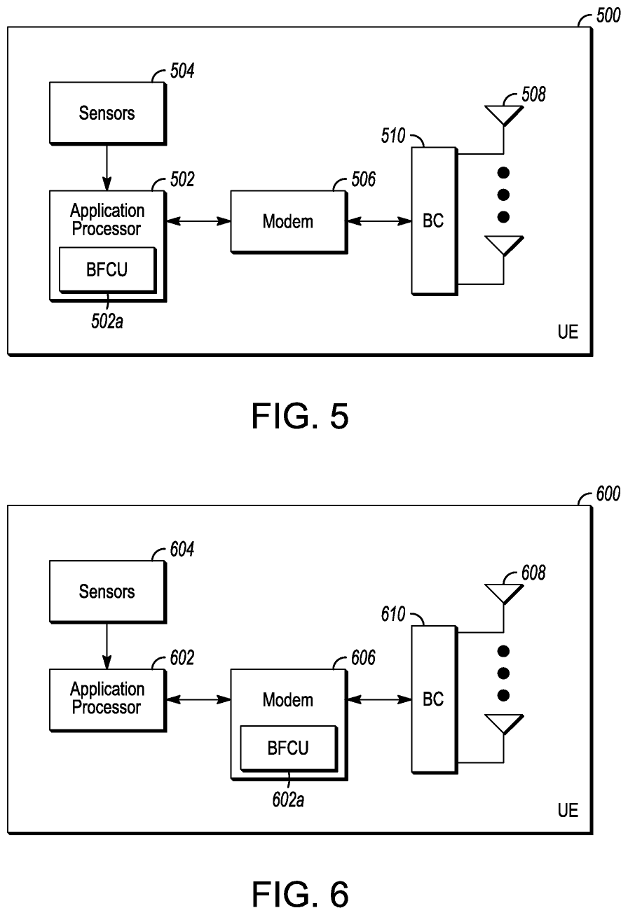

FIGS. 4-6 illustrate high level architecture of different communication devices with beam/frequency selection in accordance with some aspects. Various architectures may be used in the communication devices (drones) 400, 500, 600 of FIGS. 4-6 to illustrate different components responsible for the computation and control of beam and frequency selection. In each of FIGS. 4-6, the components are similar to those of FIG. 3: an application processor 402, 502, 602, one or more sensors 404, 504, 604, a wireless modem 406, 506, 606, and antennas 408, 508, 608. In addition, each of FIGS. 4-6 further contains beam and frequency control circuitry 410, 510, 610 and a beam and frequency computation unit 402a, 502a, 604a. In particular, in FIG. 4, the application processor 402 both computes and controls the beam and frequency selection; in FIG. 5, the application processor 502 computes the beam and frequency selection while the wireless modem 506 controls the beam and frequency selection; in FIG. 6, the wireless modem 606 both computes and controls the beam and frequency selection. Different information of the above may be provided between the application processor and the wireless modem dependent on which of the devices computes the beam and frequency selection and which of the devices controls the beam and frequency selection.

In the method of FIG. 4, for example, the beam and frequency selection may be computed and controlled by the application processor 402. In this case, the modem 406 may still provide connection status information, wireless link quality measurement and timing information for monitoring frequency bands/beam directions to the application processor 402. Similarly, the application processor 402 may provide still provide the estimated wireless link quality along the flight path to the modem 406. However, the flight path information, the current and/or near-future 3D position, velocity and orientation of the communication device 400, environment information and recommended priority list of beam direction and carrier frequency.

In particular, in FIG. 4, when the application processor 402 both computes and controls the beam and frequency selection, the modem 406 may receive an RRCConfig message or RRCReconfig message when the device 400 is to attach to a particular base station, either by initial attachment or via handover. The RRC message may contain base station information including the new serving cell ID and timing budget for beam switching. After reception of the RRC message, the modem 406 may provide the base station information to the application processor 402. After receiving the base station information, the beam and frequency computation unit 402a in the application processor 402 may compute the beam direction based on the position and orientation of the device 400, as well as the position of the base station. The application processor 402 may subsequently control the antennas 408 to form the desired beam direction before expiration of the timing budget. Thus, while data may be transmitted between the application processor 402, modem 406 and beam and frequency control circuitry 410, control signals may be transmitted between the application processor 402 and modem 406 and between the application processor 402 and beam and frequency control circuitry 410.

In addition to, or instead of, computing and controlling the beam direction for data and control communication via the network, the application processor 402 may compute and control the beam direction and frequency selection for monitoring neighboring cells via the network. In this case, the modem 406 may update the application processor measurement gap configuration. The modem 406 may also provide the neighbor cell list and frequency configuration in a measurement object to the application processor 402. The application processor 402, after receiving this information from the modem 406 may compute the UE beam direction and frequency band to scan based on the position and orientation of the device 400, as well as the neighbor cell list, which may be obtained from the measurement configuration or a network database, and positions and wireless environment estimate of the neighbor cells. The application processor 402 may then control the beam direction and carrier frequency during the measurement gap to monitor the neighbor cell(s) of interest. When the modem 406 provides the application processor 402 with the L1 or L3 measurement results and the application processor 402 provides a prediction of L1 or L3 measurement to the modem 406, the application processor 402 may update a wireless environment estimate based on the modem measurements and the modem 406 may adopt methods indicated below to adjust transmission of the L3 measurement report to the network.

In addition, or instead, computing and controlling the beam direction and frequency selection during the paging cycle may be performed. In this case, the modem 406 may provide paging cycle information (or updates) to the application processor 402. In response, the application processor 402 may compute the UE beam direction and frequency band to monitor during every paging cycle and control beam/frequency accordingly for every paging cycle based on the flight path, orientation and nearby base station locations and antenna pattern information stored in the memory.

In addition, or instead, opportunistic scanning of neighbor cells during idle mode DRX and C-DRX may be performed. In this case, the modem 406 may provide DRX and C-DRX, as well as paging message, parameters to the application processor 402. In response, the application processor 402 may compute the UE beam direction and frequency band monitoring strategy based on the DRX settings and control beam direction and carrier frequency accordingly. The application processor 402 may trigger the modem 406 to perform measurements during reception periods configured by the serving cell based on the DRX and/or C-DRX configurations and perform opportunistic measurement during non-reception periods configured by the serving cell based on the DRX and/or C-DRX configurations. The application processor 402 may also control the beam direction and carrier frequency during the measurement gap to monitor the neighbor cell(s) of interest. When the modem 406 provides the application processor 402 with the L1 or L3 measurement results and the application processor 402 provides a prediction of L1 or L3 measurement to the modem 406, the application processor 402 may update a wireless environment estimate based on the modem measurements and the modem 406 may adopt methods indicated below to adjust transmission of the L3 measurement report to the network.

As above, in the method of FIG. 5, the beam and frequency selection may be computed by the application processor 502 but controlled by the wireless modem 506. In this case, the modem 506 may still provide connection status information and wireless link quality measurement to the application processor 502 without providing the timing information for monitoring frequency bands/beam directions to the application processor 502 as the wireless modem 506 may perform these operations. The application processor 502 may provide the estimated wireless link quality along the flight path and recommended priority list of beam direction and carrier frequency to the modem 506. However, the flight path information, the current and/or near-future 3D position, velocity and orientation of the communication device 500, and environment information may not be provided from the application processor 502 to the modem 506.

When the application processor 502 computes the beam and frequency selection, but this the selection is controlled by the modem 506, the modem 506 may receive the RRCConfig message or RRCReconfig message and indicate the new serving cell ID and timing budget for beam switching to the application processor 502. After receiving the base station information, the beam and frequency computation unit 502a in the application processor 502 may compute the beam direction based on the position and orientation of the device 500, as well as the position of the base station. The application processor 502 may subsequently transmit this information to the modem 506 for the modem 506 to control the antennas 508 to form the desired beam direction before expiration of the timing budget.

As above, in addition to, or instead of, computing and controlling the beam direction for data and control communication via the network, the application processor 502 may compute the beam direction and frequency selection for monitoring neighboring cells via the network while the modem 506 effects control. In this case, the modem 506 may update the application processor measurement gap configuration as well as providing the neighbor cell list and frequency configuration in a measurement object to the application processor 502. The application processor 502, after receiving this information from the modem 506 may compute the UE beam direction and frequency band to scan based on the position and orientation of the device 500, as well as the neighbor cell list, which may be obtained from the measurement configuration or a network database, and positions and wireless environment estimate of the neighbor cells. The application processor 502 may then provide the recommended frequency and beam direction for the measurement gap to the modem 506, which then controls the beam direction and carrier frequency during the measurement gap to monitor the neighbor cell(s) of interest. When the modem 506 provides the application processor 502 with the L1 or L3 measurement results and the application processor 502 provides a prediction of L1 or L3 measurement to the modem 506, the application processor 502 may update a wireless environment estimate based on the modem measurements and the modem 506 may adopt methods indicated below to adjust transmission of the L3 measurement report to the network.

In addition, or instead, computing and controlling the beam direction and frequency selection during the paging cycle may be performed. In this case, the modem 506 may update the paging cycle information to the application processor 502. In response, the application processor 502 may compute the UE beam direction and frequency band to monitor during every paging cycle and provide the recommended frequency and beam direction for the measurement gap to the modem 506, which then may control beam/frequency accordingly for every paging cycle.

In addition, or instead, opportunistic scanning of neighbor cells during idle mode DRX and C-DRX may be performed in a manner similar to that of FIG. 4, with control being provided by the modem 506. In this case, the modem 506 may provide DRX and C-DRX, as well as paging message, parameters to the application processor 502. In response, the application processor 502 may compute the UE beam direction and frequency band monitoring strategy based on the DRX settings. The application processor 502 may trigger the modem 506 to control the beam direction and carrier frequency accordingly and to perform the opportunistic measurements. When the modem 506 provides the application processor 502 with the L1 or L3 measurement results and the application processor 502 provides a prediction of L1 or L3 measurement to the modem 506, the application processor 502 may update a wireless environment estimate based on the modem measurements and the modem 506 may adopt methods indicated below to adjust transmission of the L3 measurement report to the network.

In the method of FIG. 6, unlike the methods of FIGS. 4 and 5, computation and control of the beam and frequency selection may be undertaken by the wireless modem 606; the application processor 602 may play a limited part. In this case, the modem 606 may still provide connection status information to the application processor 602 without providing the wireless link quality measurement or timing information for monitoring frequency bands/beam directions to the application processor 602. The application processor 602 may provide the flight path information, the current and/or near-future 3D position, velocity and orientation of the communication device 600, environment information and the estimated wireless link quality along the flight path and recommended priority list of beam directions and carrier frequencies to the modem 606.

When the modem 606 computes and controls the beam and frequency selection, the modem 606 may receive the RRCConfig message or RRCReconfig message and indicate the new serving cell ID and timing budget for beam switching to the application processor 602. The application processor 602 may provide the device 300 position and orientation, as well as the position of the base station to the modem 606. After receiving the information from the application processor 602, the beam and frequency computation unit 602a in the modem 606 may compute the beam direction based on this information and control the antennas 608 to form the desired beam direction before expiration of the timing budget.

As above, in addition to, or instead of computing and controlling the beam direction for data and control communication via the network, the modem 606 may compute and control the beam direction and frequency selection for monitoring neighboring cells via the network. In this case, the modem 606 may update the application processor measurement gap configuration as well as providing the neighbor cell list and frequency configuration in a measurement object to the application processor 602. The application processor 602, after receiving this information from the modem 606 may provide to the modem 606 the position and orientation of the device 600, as well as nearby base station positions. The modem 606 may compute the beam direction and frequency band to scan based on the position and orientation of the device 600, as well as the neighbor cell list, which may be obtained from the measurement configuration or a network database, and positions and wireless environment estimate of the neighbor cells. The modem 606 may then control the beam direction and carrier frequency during the measurement gap to monitor the neighbor cell(s) of interest. When the modem 606 provides the application processor 602 with the L1 or L3 measurement results and the application processor 602 provides a prediction of L1 or L3 measurement to the modem 606, the application processor 602 may update a wireless environment estimate based on the modem measurements and the modem 606 may adopt methods indicated below to adjust transmission of the L3 measurement report to the network.

In addition, or instead, computing and controlling the beam direction and frequency selection during the paging cycle may be performed by the modem 606. In this case, the modem 606 may update the paging cycle information to the application processor 602. In response, the application processor 602 may compute the UE beam direction and frequency band to monitor during every paging cycle and provide the recommended frequency and beam direction for the measurement gap to the modem 606, which then may control beam/frequency accordingly for every paging cycle.

In addition, or instead, opportunistic scanning of neighbor cells during idle mode DRX and C-DRX may be performed in a manner similar to that of FIG. 4, with control being provided by the modem 606. In this case, the modem 606 may provide DRX and C-DRX parameters, as well as paging message, parameters to the application processor 602. In response, the application processor 602 may compute the UE beam direction and frequency band monitoring strategy based on the DRX settings. The application processor 602 may trigger the modem 606 to control the beam direction and carrier frequency accordingly and to perform the opportunistic measurements. When the modem 606 provides the application processor 602 with the L1 or L3 measurement results and the application processor 602 provides a prediction of L1 or L3 measurement to the modem 606, the application processor 602 may update a wireless environment estimate based on the modem measurements and the modem 606 may adopt methods indicated below to adjust transmission of the L3 measurement report to the network.

Computation of antenna beam directions for simple LOS channel conditions are described in detail below. If the wireless environment database contains more information, like areas with a narrowband LOS (NLOS) channel and past preferred beam directions, such information can be incorporated while computing antenna beam directions for the control architecture, signaling and procedures describe above. For determining the frequency to be scanned, the application processor may first analyze the wireless environment of near future (e.g., up to several minutes) drone trajectory, compute a priority cell scanning list and then label the frequency to be scanned along the flight trajectory. Depending on the current drone location, the application processor may provide the precomputed frequency scanning list for the control procedures described above.

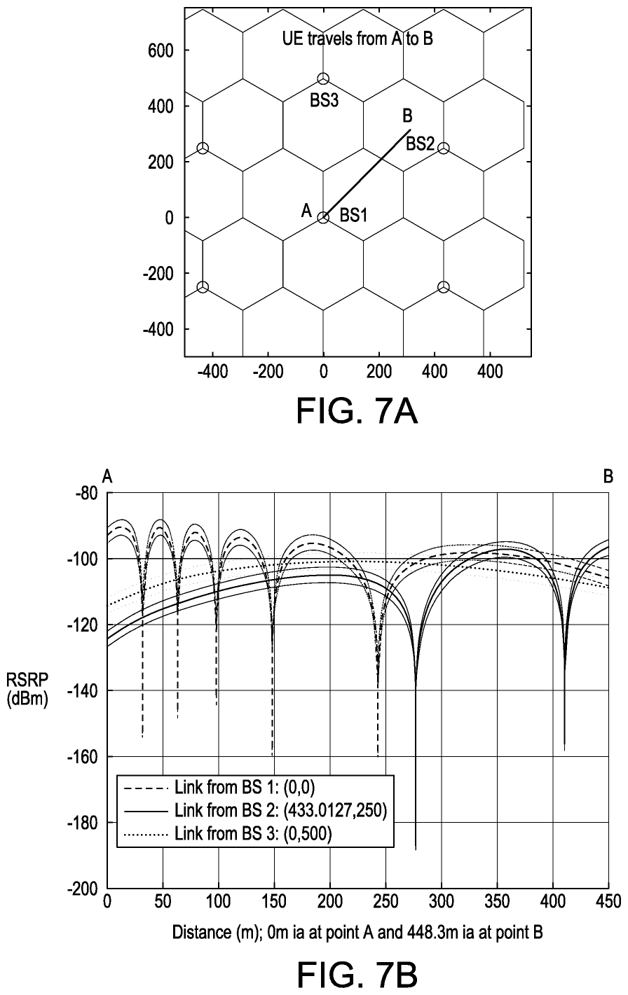

The priority cell scanning list can be computed by simply ordering the nearby RAN (eNB/gNB) according to distance from the drone or based on a signal quality estimation if additional information is available. More sophisticated algorithms that minimize unnecessary cell scanning and handover can also be designed. For example, FIGS. 7A and 7B respectively illustrate a flight path and link quality of different base stations in accordance with some aspects. As shown in FIG. 7B, the received signal strength of a drone flying from point A to point B (shown in FIG. 7A) at 100 m altitude may vary dramatically. For illustrative purposes, only the signal strength from base station (BS) 1, whose antenna main-lobe points to the upper right in FIG. 7A, BS 2, whose antenna main-lobe points to upper left in FIG. 7A, and BS 3, whose antenna main-lobe points downwards in FIG. 7A, are plotted. When BS 1, BS 2 and BS 3 are operating on 3 orthogonal frequency bands, in some aspects, the priority scanning list may be selected to contain only BS 3 while the drone travels from point A to point B. As the signal from BS 3 is fairly constant (at least in comparison to BS 1 and 2), this may avoid signal fluctuation and unnecessary handover among the BSs.

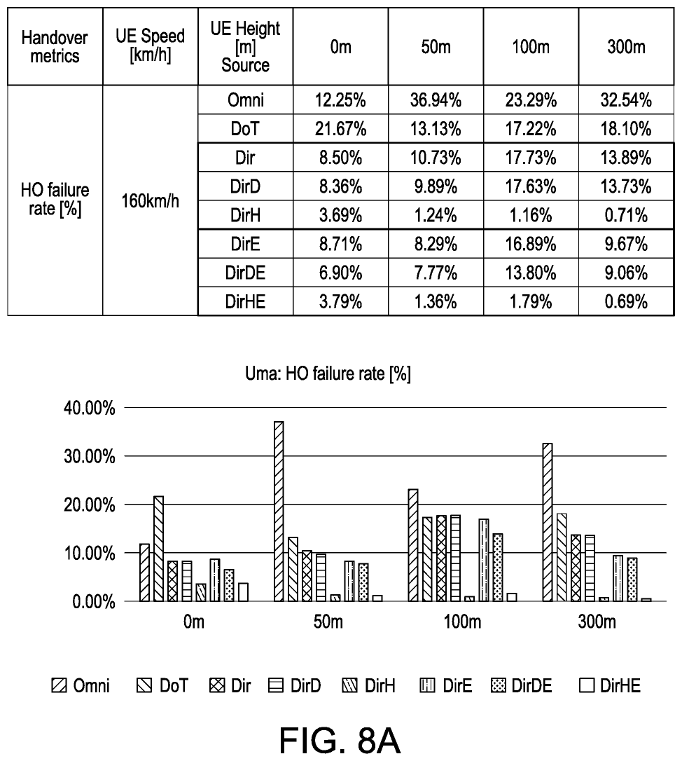

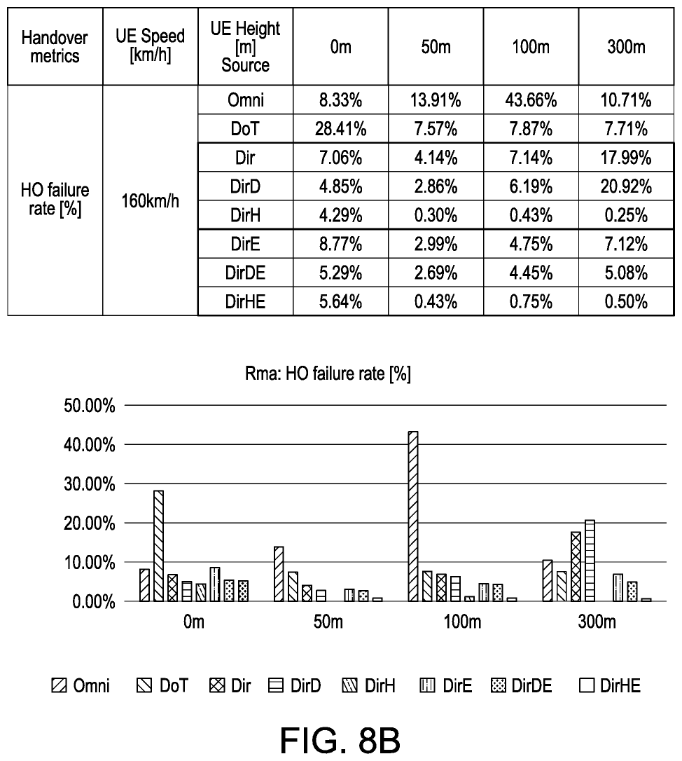

For drones equipped with both omni and directional antennas, a hybrid approach may be employed in which both antennas types are used. The modem may use directional antenna pointing towards the serving base station to support data and control communication. On the other hand, for cell selection and handover event triggering, the device may use measurement from the omni-directional antenna to provide better guidance to select the optimal serving cell. FIGS. 8A and 8B respectively illustrate the handover failure rate for urban macro-cell (UMA) and rural macro-cell (RMA) in accordance with some aspects. Simulation results of handover failure rate for drone UEs with omni and/or directional antenna with different beam alignment strategies are shown in FIGS. 8A and 8B. The legend in the FIGS. 8A and 8B is: Omni—the drone is equipped with an omni-directional antenna, DoT—Drone UE equipped with directional antenna, boresight pointing towards travel direction; Dir—the drone is equipped with a directional antenna, with the boresight pointing towards the serving base station (handover events are triggered by the directional L3 RSRP); DirB—the drone is equipped with both omni and directional antennas (the omni and directional antennas jointly form an antenna pattern); DirH—the drone is equipped with both omni and directional antennas (data and control are supported by the directional antenna, whose boresight points towards the serving base station, and handover events are triggered by the omnidirection L3 RSRP); DirE: same as Dir, except there is an error in the directional antenna boresight alignment; DirBE: same as DirB, except there is an error in the estimation of the UE-BS direction; DirHE: same as DirH, except there is an error in the directional antenna boresight alignment. As can be seen, a clear performance improvement in handover failure rate with hybrid use of omni and directional antennas is present. In addition, the hybrid use is also more robust against antenna boresight estimation error.

In order to achieve the hybrid scheme, either an extra receiver chain may be used to obtain signal strength measurement from the omni-directional antenna or a method to estimate omni antenna measurement and adjust the L3 metric for measurement report triggering may be used.

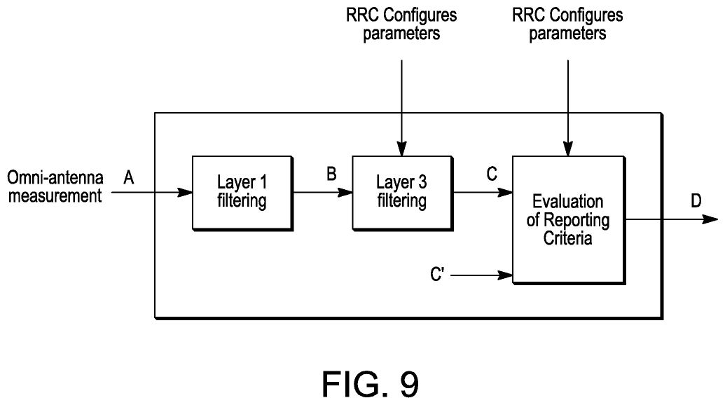

FIG. 9 illustrates a measurement model for omni-directional antenna measurement in accordance with some aspects. In particular, FIG. 9 illustrates the use of an extra receiver chain in the modem for signal strength measurement. When an extra receiver chain is built to obtain a signal strength measurement from the omni-directional antenna, the measurement from the omni-directional antenna can directly be used to compute metrics for a measurement report criteria evaluation. As shown, the omni-directional antenna measurement may be supplied to L1 filtering. The output of the L1 filtering may be supplied to L3 filtering before reporting criteria is evaluated. The L3 filtering and evaluation of reporting criteria may be configured using RRC parameters received from the network.

When additional information, such as a map of the neighboring base stations and/or wireless environment, is available, the measurement for reporting criteria evaluation can be computed from a combination of the omni- and directional antenna measurements. From past simulations, it has been observed that using a directional antenna measurement for cell selection may suffer from late handover triggering, which leads to handover failure. On the other hand, using an omni-antenna measurement for cell selection can reduce handover failure rate at the cost of frequent unnecessary handover attempts. Therefore, properly switching between omni-antenna and directional antenna measurement for cell selection may achieve an overall optimal handover performance.

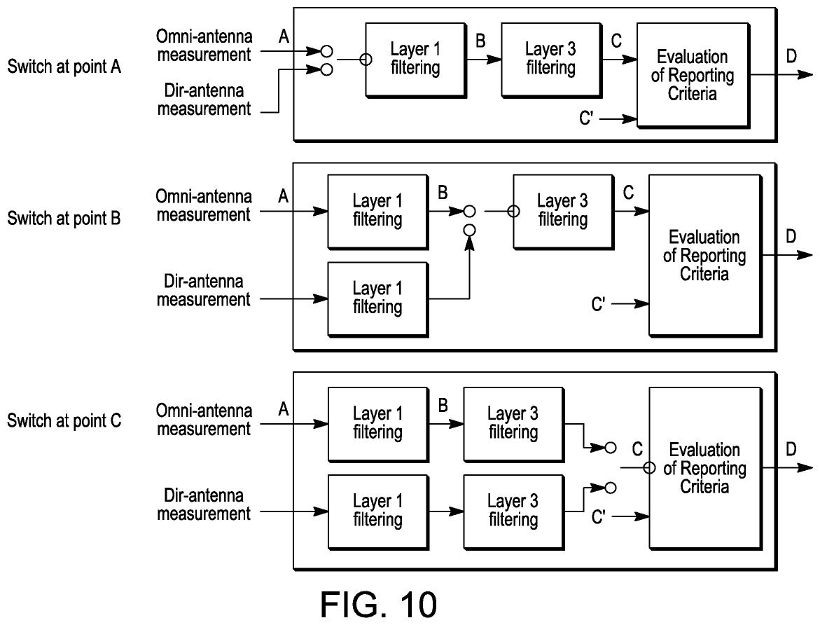

FIG. 10 accordingly illustrates a measurement model for switching between omni- and directional antenna measurements in accordance with some aspects. In particular. FIG. 10 shows three implementations in the modem to compute measurement report metrics by switching between omni- and directional antenna measurements. The switching point can be either at point A (prior to L1 filtering), B (between L and L3 filtering), or C (between L3 filtering and evaluation) as shown in FIG. 10. The switching can be controlled by the modem itself or by the application processor with an additional control interface (not shown). The components used in each receiver chain may differ dependent on the placement of the switching point. The timing to switch between omni- and directional antenna measurements may be based on the available information. For example, based on a wireless environment database and drone flight path, an optimization problem can be formulated to compute the switch timing that minimize handover failure rate and ping-pong probability.

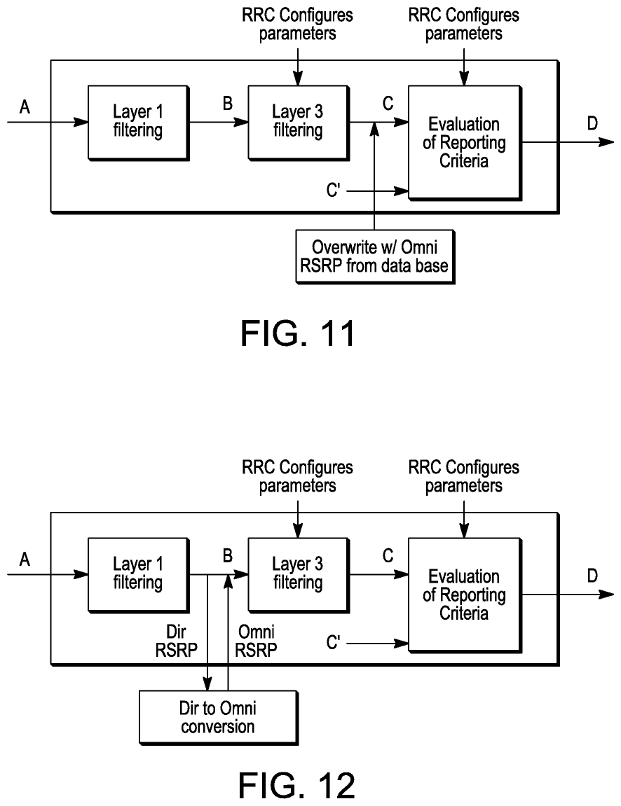

When an extra receiver chain is not available, the estimation of the omni-directional antenna measurements may be used to evaluate the reporting criteria. To this end, either a wireless environment database or a directional antenna measurement may be used to estimate the omni-directional measurement. FIG. 11 illustrates replacing a wireless environment database using an omni-directional antenna measurement estimation in accordance with some aspects. In this case, the application processor may provide to the modem an estimation of L1 and/or L3 measurements based on the drone flight path and database information. The modem may then choose whether to overwrite the L1 and/or L3 measurement. As shown in FIG. 11, the omni-directional antenna measurement may intercept the estimation from the database (provided by the application processor to the modem) at point C—i.e., after L3 filtering and before evaluation of the reporting criteria. Other variations of the implementations may also exist, such as intercepting the information in the receiver chain at point A or point B. The application processor may also provide extra instructions to the modem to help the modem determine when to overwrite the information.

Based on the UE directional antenna pattern and a map of the base stations, the modem or the application processor may be able to estimate the omni-directional antenna measurement from directional antenna measurements. FIG. 12 illustrates converting a directional antenna measurement to an omni-directional antenna measurement in accordance with some aspects. As shown in FIG. 12, the omni-directional measurement may intercept the directional antenna measurement at point B, converting and overwriting the directional L1 measurement to the omni-directional measurement estimate before L3 filtering. Other variations of the implementations may also exist, such as intercepting the information in the receiver chain at point A or point C.

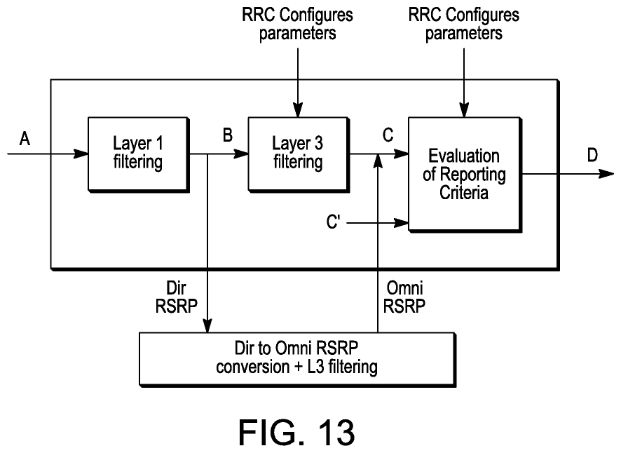

FIG. 13 similarly illustrates converting a directional antenna measurement to an omni-directional antenna measurement in accordance with some aspects. In this aspect, the overwriting may occur at a later point of where the reference directional measurement is obtained. As illustrated in FIG. 13, the reference directional antenna measurement at point B may be used to compute the estimated ormi-directional antenna measurement. The estimate may then overwrite the L3 filtered directional antenna measurement at point C. Other variations may use the reference directional measurement at point A and overwrite the omni-directional antenna measurement estimate at point B or C.

In some aspects, a high-directivity antenna may be implemented in drones, automobiles, and aircraft. The high-directivity antenna can not only improve communication range but also help mitigate interference to/from other non-serving base stations or device-servicing stations (DSS). However, higher antenna directivity is more vulnerable to antenna misalignment, especially for 5G mmWave radios, which have a much higher free space path loss (FSPL) and thus use a high gain and high directivity antenna together with the condition of line-of-sight between the UE antenna and DSS antennas. Thus, it may desirable for both BS/DSS and UE to timely direct the antenna beam to the right direction for uninterrupted quality of service. In the following, information such as the BS-DSS and UE locations, DSS and UE velocities, UE travel trajectory, antenna orientations, and/or 3D wireless environment map may be used to improve UE beam scanning efficiency. Sensor inputs can be used to detect sudden turns or elevation changes of the drone UE.

In some embodiments, the drone (or automobile) UE may be equipped with a number of hardware components. These hardware components may include one or more of: a barometer to measure altitude, GPS to provide current absolute global location and velocity; orientation detection devices such as an IMU or accelerometer, magnetometer and/or gyroscope to provide orientation of the antenna point and the detection of sudden change in direction; a data storage memory to store nearby DSSs, such as cell base stations, and other mobile servicing stations information (e.g., global locations, RF powers, antenna patterns) and a road map of the driving routes within zones; and an application processor for data process and decision making of the UE's antenna beams. Similarly, the drone/automobile servers (DAS) may include one or more of; UE and DSS antenna beams and patterns, DSS Tx powers and DSS locations; recorded historic route parameters from previous drone flights or vehicle trips driving; a database of all mobile DSS current locations and their antenna orientations; the latest global drive/flight map; and examples of data flow. The UE may provide r, v vectors and a minimum throughput request to the DSS. The DSS may, in response, provide feedback with the antenna beams and power and maximum throughput of the UE and/or a new proposed path and velocity.

Beam control, as well as DSS antenna beam control, can be performed at the UEs as indicated below. The assignment of the target beam and priority beam list can be determined based on the UE location and DSS locations. Once the target beam is determined, the UE may gradually switch to the next target beam based on the velocity vs. the same DSS. The UE may detect a sharp turn or elevation changes detected by the orientation sensor and set a new target beam based on the change vector of the Azimuth and Elevation angles. When a new DSS is assigned, the UE may calculate the new target beam.

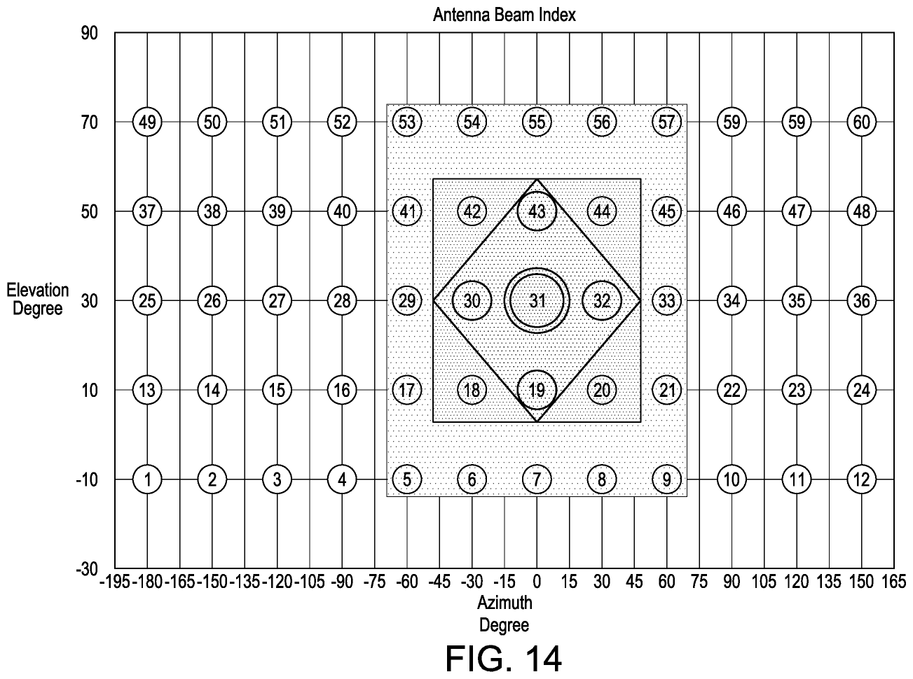

Multiple pieces of information may be used to determine the priority list. FIG. 14 illustrates UE antenna beam index mapping in accordance with some aspects. In FIG. 14, if the serving DSS is located at an azimuth of zero degrees and an elevation of 30 degrees from the UE antenna point of view, then an example priority list can be the following: Target beam 31 (0, 30) (big circle); Secondary beams: 30, 32, 19, 43 (diamond); Third list: 18, 20, 42, 44 (inner square); Fourth list: 5, 6, 7, 8, 9, 17, 21, 29, 33, 42, 45, 53, 54, 55, 56, 57 (outer square).

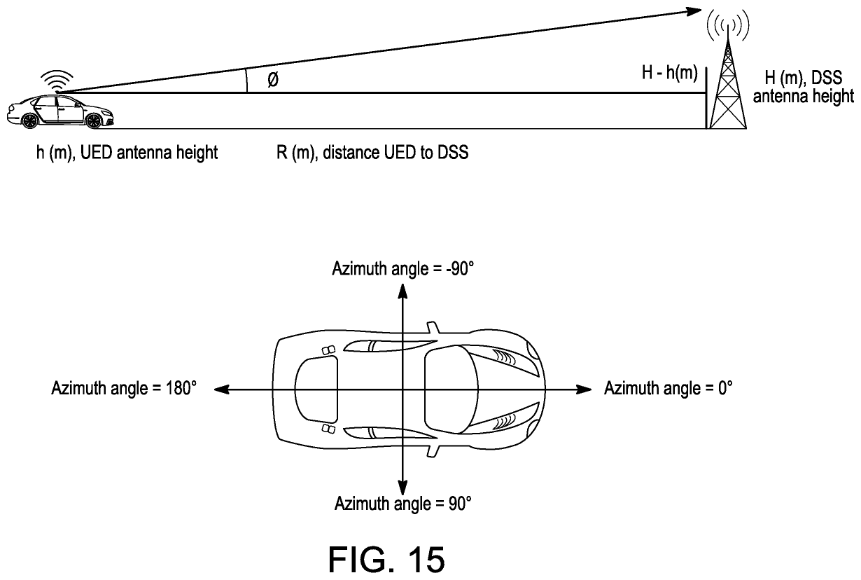

FIG. 15 illustrates determining the serving beam direction in accordance with some aspects. In particular, the UE may be able to derive the azimuth and elevation angle for the best serving beam. FIG. 15 shows an example of a vehicle in 2D motion, which can readily be extended to selection of the best serving beam for a drone in 3D motion. That is the determination made by the application processor or modem of a drone may follow a similar approach as that shown in FIG. 15 to calculate the target beam and the priority lists of antenna beam indexes based on azimuth and elevation angles of the drone's antenna. As shown, to find the elevation angle from the UE antenna to the DSS antenna, the arctan may be taken of the difference between the DSS and UE antenna heights (H-h) divided by the horizontal distance of the UE antenna to the DSS antenna. The azimuthal angle may be defined to be 0° in relation to the front of the vehicle, with the azimuthal angle increasing positively in the clockwise direction and increasing negatively in the counterclockwise direction to the rear of the vehicle, which is defined as 180°. As shown, h(m) is the UE antenna height, H(m) is the DSS antenna height, R(m) is the distance from the UE to the DSS, ϕ is the elevation angle from the UE antenna to the DSS antenna and θ is the azimuth angle of the UE antenna to the DSS.

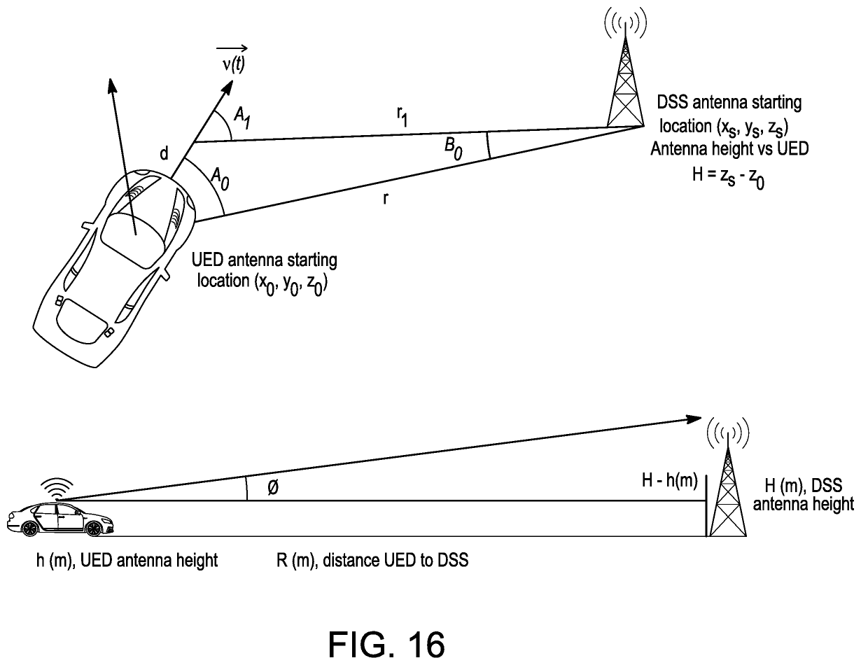

The UE of FIG. 15 may gradually switch to the next target beam base in a travel direction vs. the same DSS. FIG. 16 illustrates angular change of the best serving beam in accordance with some aspects. The parameters are defined as r: obtained from the UE and DSS GPS locations, A₀ (azimuth angle) is from the r vector and the UE velocity vector (determined by the orientation sensor and GPS), T is the time to travel to the next calculation, and v₀ is the velocity @ t=0/velocity (t=T (constant velocity or acceleration). In particular, as shown, when the UE travels on a straight road, its travel direction may have an azimuth angle of A₀° with respect to its location to the DSS. To calculate the UE beam angles for the current position and after time t sec, the UE may use its antenna and DSS locations to calculate r, the distance to the DSS. The UE may also use its orientation sensor/GPS to obtain the velocity v and direction of the UE. The UE may then use the product of v and r to obtain the azimuth angle A₀° (A₀=cos⁻¹ (\tilde{v} dot r)) for UE beam selection. The UE may determine the elevation angle E₀° as above (E₀°=tan⁻¹(H/r)), where H is DSS antenna height less the UE antenna height. The UE may determine the UE travel distance after t seconds as: d=½*(v₀+v₁)*t. The UE may then use the law of cosines to calculate the new distance r₁ to the DSS: r₁=d²+r²−2*d*r cos(A₀. Similarly, the UE may then use the law of sines to calculate the angular change between the previous UE location and the current UE location as: B₀=cos⁻¹(d/r₁*sin(A₀)). The new azimuth angle after t second is A1=A0+B0. The new elevation angle after t second is E₀°=tan⁻¹(H/r₁). The calculation results, together with a stored road map, can be used for the estimate to determine beam selection, scanning and switching to a new beam after t second. If the UE switches to a new DSS, the new Azimuth and elevation angles for the new DSS may be determined using the above operations.

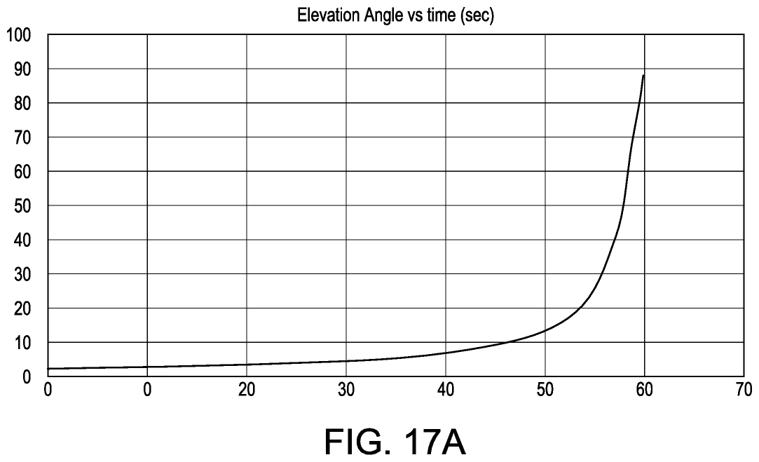

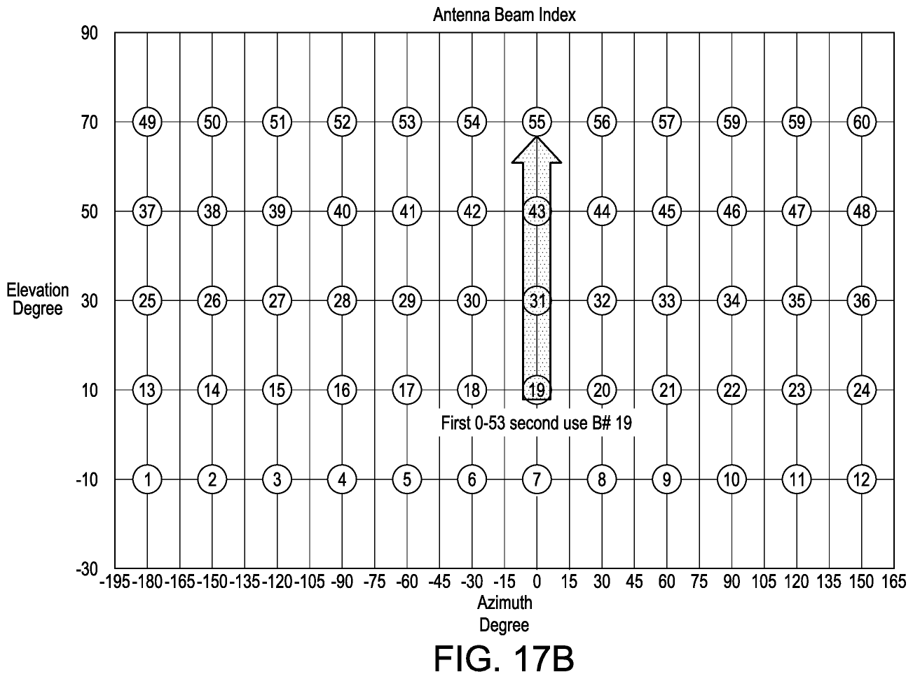

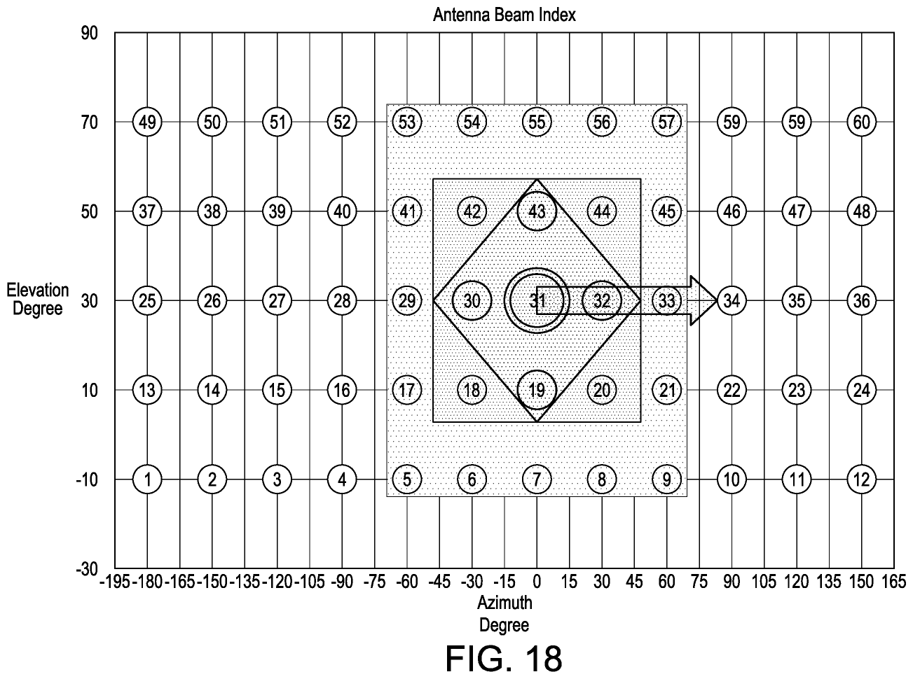

FIG. 17A illustrates elevation change as a function of time in accordance with some aspects and FIG. 17B illustrates a priority list change in accordance with some aspects, while FIG. 18 illustrates another priority list change in accordance with some aspects. In one example, the UE approaches the DSS at an azimuthal angle of 0 degrees, the UE speed is 60 km/h, the UE to DSS distance is 1 km, the UE antenna height 1 m and the DSS antenna height is 40 m. As shown in FIG. 17A, the elevation angle remains substantially constant over a significant amount of the time (53/60 s), before increasing rapidly. This leads to the use of beam 19 (B19) over the same time period before rapidly switching to B31, B43 and finally to B55 over the last 7 s as shown in FIG. 17B. As shown in FIG. 18, in which the UE (or autonomous UE) makes a sharp turn at a four-way intersection, the UE initially uses B31. The UE enters the intersection and makes a 5 m 90 degree turn at 20 km/s, taking 1.5 seconds. The UE has an orientation sensor that is capable of detecting a change of 100 degrees over 100 ms. The orientation sensor indicates a change in UE orientation, and the UE starts to probe the neighbor beam where the angle detected by the orientation sensor until the UE determines that it is heading in a constant direction. Specifically, the UE switches from initially using B31 to terminate using B34 after using each of B32 and B33 for roughly 500 ms in between (switching to B32 at t=500 ms, B33 at t=1 s and B34 at t=1.5 ms).

The UE may then set the new priority list and scan beams based on the priority order to find the best beam with the desired RF signal strength and/or quality. The remaining lower priority beams may be terminated and the final beam set as the new working target beam with a new working PL defined. As shown, the new active priority lists indicate that the target beam is 34 (0, 30), the secondary beams are 33, 35, 22 and 46, the third list includes beams 21, 23, 45 and 47 and the fourth list includes beams 8, 9, 10, 11, 12, 20, 24, 32, 36, 45, 48, 56, 57, 58, 59, and 60.

In addition to changes in the architecture and methodology of using the modem in the UE, enhancement in RAN-level measurement collection by drones may be beneficial for operator cell planning and configuration, as well as for operation of a Self-Organizing Network (SON). RAN-level measurement collection may help to ensure reliable communication links between drones and ground control stations. As above, cellular technology is a good candidate for drone applications covering a wide area and in which a quality-of-service guarantee may be associated with data communication. However, existing cellular infrastructures are not optimized for aerial communication, and collection of RAN-level measurements for 3D coverage, which may be lacking in at least some areas, may be beneficial for network operation. Moreover, the network may not be able to utilize information available in most drone operations simply because there is no implementation at the UE to include useful 3D information in the report. In particular, implementation enhancements for Minimization of Drive Test (MDT) for RAN-level data collection using drones or other unmanned aerial vehicles are described to improve MDT data collection efficiency for exploring cell coverage condition at elevated altitudes. To this end, utilization of information available at drones to enhance RAN-level data collection and three-dimensional considerations for measurement triggering (e.g., height triggering) may be provided. Such drone information may include, for example, reporting local sensor measurements and flight path information, among others.

Thus, various aspects may combine sensor measurement and/or flight path information to the MDT log transmitted from the drone to the network. The drone may also engage in opportunistic logging of MDT measurements even during out-of-coverage conditions or while suffering in-device coexistence. The drone may furthermore undertake MDT measurement calibration when collecting RAN-level measurements from moving gNBs (e.g., Cells-On-Wing), as well as the aforementioned addition of height and/or area-based measurement triggering.

As above, the methods described may be used to improve existing MDT and other RAN-level measurement procedures. They can also be applied to scenarios where UE modems can self-trigger the MDT and/or other RAN-level measurement collection mechanisms regardless of cellular network signaling. The RAN-level measurement data can be retrieved either by an application in the cloud or by direct download (e.g., via a direct connection, such as a USB or a wireless connection, such as WiFi) for analysis. A cloud application example to utilize the RAN-level measurement could be a ‘communication advisory subsystem’ that maintains a 3D wireless environment database and uses the database to assist UE traffic management (UTM). These may also be used for terrestrial vehicular UEs, for example, ground vehicles can use a flight path information report to inform the network of a future or past travel path by the ground vehicle to enhance ground vehicle support.

Combining sensor measurement and/or flight path information in the MDT log may include combining information from the one or more sensors (e.g., barometers. GPS, gyroscopes) in the drone. The drone may be able to detect and record valuable side information for understanding RAN-level data collected via MDT and/or other RAN-level feedback reports. For example, the orientation measurements from a gyroscope mounted in the drone may be used to calibrate a received signal strength measurement based on antenna beam pattern after orientation adjustment. In another example, when the drone performs dynamic movements, odometer and gyroscope recording can help identify the actual cause for signal strength fluctuation.

Existing MDT reports only include location information—no signaling has yet been defined for incorporating sensor measurements in RAN-level data collection. Accordingly, as discussed herein, the UE modem can tag sensor measurements with the time stamps for RAN-level data collection, so a cloud server or local analysis engine can correlate RAN-level measurement with sensor readings when analyzing 3D wireless environment.

Implementations of sensor data recording can include use of a parallel logging process or separate thresholds for the sensors. In the former case, during MDT recording or other RAN-level data collection, a parallel logging process may be used to store the sensor reading whenever a MDT or RAN measurement is made so that all sensor readings are properly in sync with the MDT/RAN measurement. In the latter case, one or more of the sensor readings may only be recorded when a predetermined detection threshold is met (e.g., for that sensor or for a combination of sensors). The sensor reading may include a time stamp that is sync with the MDT/RAN measurement procedure. In this case, the detection threshold for a particular sensor may include: when the difference between the current sensor reading and the last logged (or immediately preceding) sensor reading is above the threshold, when the sensor reading exceeds the threshold (e.g., an odometer reading is above the threshold), and/or when the gradient of the sensor reading (defined as the difference of two of the sensor readings measured at different times separated by a predetermined duration) exceeds certain threshold (e.g., a gyroscope reading that detects rapid rotational movement). The duration may be larger or smaller than the time difference for taking adjacent MDT measurements.

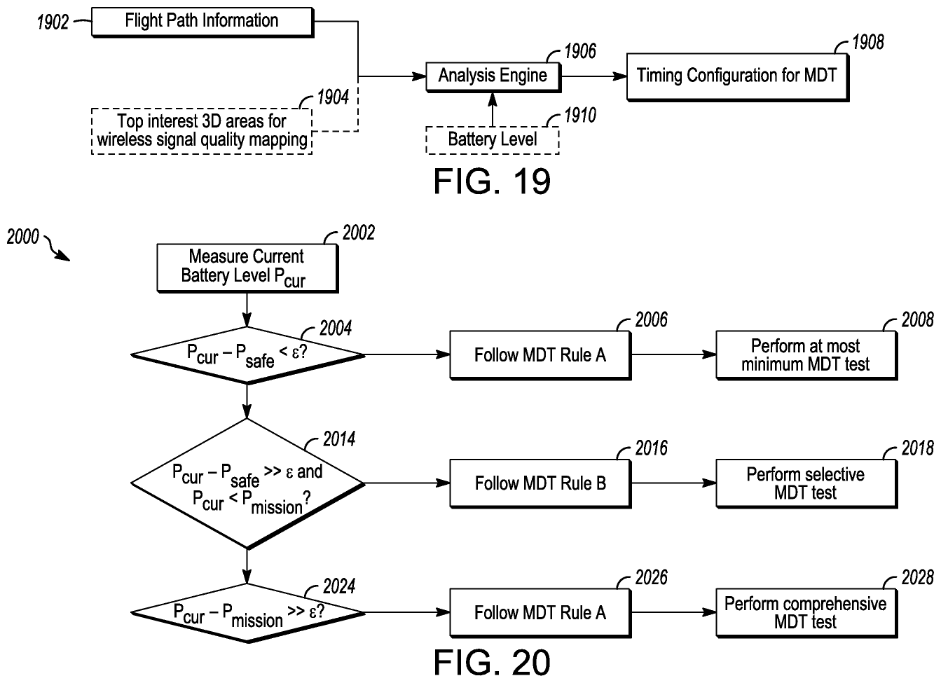

Other useful information that may be incorporated in the MDT or RAN-level measurements is the flight/travel path information. FIG. 19 illustrates a timing configuration computation in accordance with some aspects. For most drone operations, the drone flight path may be known beforehand, permitting 3GPP Rel-15 to define signaling for drones to report their flight path information. The flight path information 1902 can be used to enhance the MDT/RAN-measurement procedure 1900 shown in FIG. 19. In particular, when an accurate location reading is not available from GPS or other location sensors, the UE modem can choose to use the flight path information 1902 to estimate the drone current location using an analysis engine 1906 and record the current location in the MDT log or RAN-level measurements. Alternatively, or in addition, as indicated by the flight path information 1902, the modem can configure a specific time duration for MDT logging 1908. This may conserve power and memory by only logging the wireless environment in one or more areas of interest 1904 by mapping the area to the timing according to the flight path information 1902. In some cases, as explained in more detail below, the analysis engine 1906 may also take into account the battery level of the drone 1910.

Existing 3GPP signaling only allows a UE to log a measurement if the UE is attached to a cell in a configured cell list of the UE and if there is no in-device coexistence (IDC) issue. However, for drone applications that travel mostly in uncharted wireless environments in which few past statistics have been recorded for the wireless coverage conditions in the sky, logging location information of outage areas may be helpful to chart an aerial wireless signal quality map. To this end, the modem may be enhanced to opportunistically perform MDT logging even during outage or IDC. To accomplish this, in some aspects, the modem can be preprogrammed or configured by a remote device, such as a cloud application server, to perform MDT logging even when the UE is not camped/connected to a configured list of eNB/gNBs or when the UE is suffering IDC issues.

Alternatively, the modem may be preprogrammed or configured by the remote device/cloud application server to perform MDT logging under a set of pre-configured conditions regardless of the configurations from cellular networks. Examples of the pre-configured conditions may include when the drone is in outage or suffering from IDC issues and: a change of travel direction and/or orientation is detected at the drone and/or the drone is entering a preconfigured 3D area. The modem can be preprogrammed or configured by remote cloud application server to perform MDT measurement from other radios even when the UE is detached from the network or suffering from IDC issues.

In addition, as above, cellular operators are exploring new deployment scenarios with moving eNB/gNB, such as Cells-On-Wing and Cells-On-Wheel. However, when MDT or any other RAN-level measurements are obtained from a moving eNB/gNB, the moving trajectory of gNB/eNB should be combined with RAN-level measurements to produce meaningful analysis. Thus, a network-side implementation to incorporate moving gNB/eNB trajectory while analyzing MDT or other RAN-level measurements is described.

In a first aspect, a data analysis engine may directly collect moving gNB/eNB trajectories. In this case, a central analysis entity, similar to the trace collection entity (TCE) may exist. The central analysis entity may incorporate the trajectory of the moving gNB/eNB while analyzing RAN-level measurements. If the moving gNB/eNB trajectory is controlled by one or more network elements, the network elements may update the central analysis entity with the gNB/eNB trajectory. If the moving gNB/eNB autonomously controls its own trajectory, a signaling exchange (standardized or proprietary) may be initiated for the central analysis entity to obtain the gNB/eNB location update. Independent of the entity or manner in which the central analysis entity obtains the gNB/eNB trajectory and location, the central analysis entity may examine the collected traces and extract traces relating to the moving gNB/eNB. The related traces may include either or both direct measurements from gNB/eNB or traces that includes interference impact from the moving gNB/eNB.

In a second aspect, the gNB/eNB may incorporate moving gNB/eNB trajectory information in RAN-level measurements. In this case, the gNB/eNB may obtain a list of the physical cell ID (PCI) of nearby moving gNBs/eNBs. This information may be provided by operators or obtained via signaling (X2 or proprietary) between gNBs/eNBs. The gNB/eNB may then examine the MDT log and/or other RAN-level measurements from a UE. If the measurements relate to a moving gNB/eNB, the gNB/eNB may communicate with the moving gNB/eNB via the (X2 or proprietary) signaling to obtain the past trajectory of the moving gNB/eNB. This may be repeated for each moving gNB/eNB. The gNB/eNB may combine the moving gNB/eNB trajectory in the measurement when reporting the traces to the trace collection entity.

In another aspect, height and/or area-based measurement triggering may be performed. In particular, memory storage for logging radio-level data may be of concern for MDT. If the drone operators have specific interest in learning the signal quality of a given 3D area, a finer granularity of area information (compared with the existing standard that only allows for configuring cell ID list of interest) can be configured for RAN-level measurement logging to achieve more efficient use of memory storage. For example, a height threshold to trigger RAN-level data collection may be used to greatly reduce the amount of MDT data storage for drone applications. In this case, the modem can be pre-programmed or remotely configured by a cloud application server (or other device) to trigger an MDT measurement when the UE altitude is above a predetermined threshold and/or when the UE enters a particular 3D area of interest. In further embodiments, the modem can be pre-programmed or remotely configured to trigger an MDT measurement with different MDT configurations, e.g., different measurement time intervals, when the UE altitude is between different ranges and/or when the UE enters different 3D areas of interest.

However, MDT and RAN-level data collection by drones, whether or not moving gNBs/eNBs are present, may be affected by the remaining power (i.e., battery life). As is apparent, battery life may be of concern for operating unmanned aerial devices/drones. Because of the limited power in such applications, a drone may adjust its communication strategy, including for MDT, to guarantee safe and reliable operation dependent on the current battery level of the drone. Without taking into account the power constraints for drone safety and mission execution, a drone may waste power performing unnecessary measurements and message exchange, which can lead to mission failure. Thus, in some embodiments, an aero board of the drone (which may contain the application processor, memory and connectivity components) and modem may be supplied with a battery, and a battery level report may be provided to the modem from the application processor.

In some aspects, the drone may be given different priorities for the battery usage. In particular, the highest priority may be given to drone safety operation and a lower priority may be given to mission completion. In this case, a minimum battery level for drone safety operation (such as emergency landing) may be defined as P_{safe}; a minimum battery level for mission completion may be defined as Pₘᵢₛₛᵢₒₙ. In general, Pₘᵢₛₛᵢₒₙ>P_{safe}, the battery level can be an absolute value or a relative percentage value. In one example, P_{safe}=5% and Pₘᵢₛₛᵢₒₙ=20% of the absolute battery life. However, either or both battery life threshold may differ from this example.

FIG. 20 illustrates power-aware Minimization of Drive Test (MDT) reporting in accordance with some aspects. The MDT power-aware method 2000 first measures the current battery level at operation 2002. This measurement may occur periodically, with the period being constant or being dependent on operations of the drone (e.g., amount of time communicating, drone velocity, previous battery level). The drone may follow different MDT rules dependent on the relative amount of battery life compared with the power for mission completion and for safety.

Specifically, as shown in the method 2000, if the modem determines, at operation 2004, that P_{cur}−P_{safe}<ε, where ε is a small value (say about 1-10%; that is the current power is at most incrementally greater than the safety power level), the drone may follow MDT configuration rule A at operation 2006. If the modem determines, at operation 2014, that if P_{cur}−P_{safe}>>ε, and P_{cur}<Pₘᵢₛₛᵢₒₙ, the drone may follow MDT configuration rule B at operation 2016. Similarly, if the modem determines, at operation 2024, that if P_{cur}−Pₘᵢₛₛᵢₒₙ<ε, the drone may follow MDT configuration rule C at operation 2026. Note that while the same value of ε may be used for each determination, in other embodiments, the value of ε may be different in one or more of the determination operations 2014, 2024, 2034.

The MDT configuration rules indicated at operations 2016, 2026, 2036 may indicate the manner in which MDT testing and/or reporting is to occur. As indicated, when MDT rule A is to be followed at operation 2006 (the power level is slightly above or marginally higher than the minimum battery level for drone safety operation), the drone may perform a minimum number of MDT measurements (without reporting these measurements to the network), or may avoid performing any MDT measurements at operation 2008. In addition, an MDT measurement interval may be set to be the largest available value. In addition, a number of measurements may be deactivated, including, for example, IDC detection and measurement, Bluetooth (BT) measurements, Wireless Local Access Network (WLAN) measurements etc. The reduction of these measurements may not impact device mobility performance—the drone may continue to measure the serving cell and neighbor cell measurements as per 3GPP expectations so that mobility performance is still achieved.

When MDT rule B is to be followed at operation 2016 (the power level is sufficiently higher than the minimum battery level for drone safety operation, but lower than the battery level for mission completion), the drone may perform selective MDT measurements at operation 2018. In addition, an MDT measurement interval may be set to be a medium value between the largest and smallest intervals. Performing an IDC measurement may be optional when MDT rule B is followed. In addition, while measurements may be taken, reporting of the measurements may not occur immediately. For example, the drone may choose to perform an MDT measurement during the flight, but only report the MDT measurement to network after completing the mission. If the battery level is too low to report the MDT measurement to the network, the drone may resume MDT feedback after its battery is charged.

When MDT rule C is to be followed at operation 2036 (the power level is sufficiently higher than the battery level for mission completion), the drone may perform a more comprehensive set of MDT measurements at operation 2028. In addition, an MDT measurement interval may be set to be the smallest available value and IDC measurements may be performed.

The above parameters (e.g., MDT interval, threshold levels, types of measurements taken and whether reporting occurs) may also be geographically based. This is to say that in certain 3D areas of interest it may be more desirable to take MDT measurements than in other locations, and one or more of the parameters may be adjusted accordingly. Referring to FIG. 19, the flight path information for drones can also be incorporated in the power-aware MDT configuration. With the flight path information, MDT logging in the area of interests may be configured. Thus, the current battery information can also be included when deciding a future MDT configuration. Given the current battery level and the future flight path information, the analysis engine 1906 can estimate future power usage and try to compute multiple MDT configuration settings at different timings (depending on the expected timing for the drone to fly to the area of interest and the remaining energy available). For example, if only limited battery is available, the analysis engine 1906 can choose to only configure one or more of the most important areas to perform MDT logging. An individual MDT priority may thus be associated with each of the different areas.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus, the following claims are hereby incorporated into the Detailed Description, with each claim standing on its own as a separate aspect.

What is claimed is:

1. An apparatus of a drone, the apparatus comprising:
sensors arranged to determine a geographic location and an orientation of the drone;
a plurality of antennas configured to form a beam through which the drone communicates data and control signals with a serving cell using a carrier frequency;
an application processor; and
a wireless modem arranged to communicate with the serving cell through the antenna and with the application processor, the modem configured to provide to the application processor connection status information, the application processor configured to provide to the modem estimated wireless link quality along a flight path of the drone, the connection status information and estimated wireless link quality used during computation and control of a direction of the beam and the carrier frequency by at least one of the application processor or the modem based on the connection status information.

2. The apparatus of claim 1, wherein:
the application processor is configured to compute and control the beam direction and the carrier frequency, and
in addition to the connection status information, the modem is configured to provide to the application processor:
wireless link quality measurements including at least one of: layer 1 (L1) or layer 3 (L3) reference signal received power (RSRP) of the serving cell and at least one top interfering cell, at least one of L1 or L3 layer reference signal received quality (RSRQ), or an indication of physical layer out-of-sync detection, and
timing information for monitoring different frequency bands or beam directions, including one or more of: settings of a measurement gap, a paging cycle, idle-mode discontinuous reception (DRX) and connected-mode DRX (C-DRX) configurations, measurement configurations and a list of neighbor cells to monitor.

3. The apparatus of claim 2, wherein:
the modem is configured to, in response to reception of a Radio Resource Control (RRC)Config message or RRCReconfig message that comprises base station information including a new serving cell identification (ID) and timing budget for beam switching to communicate with the new serving cell, provide the base station information to the application processor, and
in response to reception of the base station information, the application processor is configured to:
compute a new beam direction for communication with the new serving cell based on position and orientation of the drone and position of the new serving cell, and
control the antennas to form the beam direction before expiration of the timing budget.

4. The apparatus of claim 2, wherein:
the modem is configured to provide to the application processor neighbor cell information comprising: the measurement gap configuration and neighbor cell list and frequency configuration of neighboring cells in the neighbor cell list, and
in response to reception of the neighbor cell information, the application processor is configured to:
compute the beam direction and frequency band to scan for neighbor cells on the neighbor cell list based on position and orientation of the drone and positions and frequency configuration of the neighbor cells, and
control the antennas to form beams to monitor the neighbor cells during a measurement gap indicated by the measurement gap configuration.

5. The apparatus of claim 2, wherein:
the modem is configured to provide the paging cycle configuration to the application processor, and
in response to reception of the paging cycle configuration, the application processor is configured to compute and control the beam direction and frequency band to monitor the serving cell during the paging cycle based on the flight path, position and orientation of the drone, and position of neighbor cells and antenna pattern information of the neighbor cells.

6. The apparatus of claim 2, wherein:
the modem is configured to provide the DRX and C-DRX configurations to the application processor, and
in response to reception of the DRX and C-DRX configurations, the application processor is configured to:
compute and control the beam direction and frequency band to monitor based on the DRX and C-DRX configurations, and
trigger the modem to perform measurements during reception periods configured by the serving cell based on at least one of the DRX or C-DRX configurations and perform opportunistic measurement during non-reception periods configured by the serving cell based on the at least one of the DRX or C-DRX configurations.

7. The apparatus of claim 1, wherein:
the application processor is configured to:
compute the beam direction and the carrier frequency, and
in addition to the estimated wireless link quality, provide to the modem a priority list of beam directions and carrier frequencies, and the modem is configured to:
control the beam direction and the carrier frequency, and
in addition to the connection status information, provide to the application processor timing information for monitoring different frequency bands or beam directions, including one or more of: settings of a measurement gap, a paging cycle, idle-mode discontinuous reception (DRX) and connected-mode DRX (C-DRX) configurations, measurement configurations and a list of neighbor cells to monitor.

8. The apparatus of claim 7, wherein:
the modem is configured to, in response to reception of a Radio Resource Control (RRC)Config message or RRCReconfig message that comprises base station information including a new serving cell identification (ID) and timing budget for beam switching to communicate with the new serving cell, provide the base station information to the application processor, and
in response to reception of the base station information, the application processor is configured to:
compute a new beam direction for communication with the new serving cell based on position and orientation of the drone and position of the new serving cell, and
signal the modem to control the antennas to form the beam direction before expiration of the timing budget.

9. The apparatus of claim 7, wherein:
the modem is configured to provide to the application processor neighbor cell information comprising: the measurement gap configuration and neighbor cell list and frequency configuration of neighboring cells in the neighbor cell list, and
in response to reception of the neighbor cell information, the application processor is configured to:
compute the beam direction and frequency band to scan for neighbor cells on the neighbor cell list based on position and orientation of the drone, positions and frequency configuration of the neighbor cells and the wireless environment estimate, and
provide the beam direction and frequency band to the modem to control the antennas to form beams to monitor the neighbor cells during a measurement gap indicated by the measurement gap configuration.

10. The apparatus of claim 7, wherein:
the modem is configured to provide the paging cycle configuration to the application processor,
in response to reception of the paging cycle configuration, the application processor is configured to:
compute the beam direction and frequency band to monitor during the paging cycle based on the flight path, position and orientation of the drone, and position of neighbor cells, and
provide the beam direction and frequency band to the modem, and
the modem is further configured to control the antennas to form the beam to monitor the serving cell during the paging cycle based on the beam direction and frequency band from the application processor.

11. The apparatus of claim 7, wherein:
the modem is configured to provide the DRX and C-DRX configurations to the application processor,
in response to reception of the DRX and C-DRX configurations, the application processor is configured to:
compute the beam direction and frequency band to monitor based on the DRX and C-DRX configurations,
provide to the modem the beam direction and frequency band to monitor based on the DRX and C-DRX configurations, and
trigger the modem to perform measurements during reception periods configured by the serving cell based on at least one of the DRX or C-DRX configurations and perform opportunistic measurement during non-reception periods configured by the serving cell based on the at least one of the DRX or C-DRX configurations, and
the modem is further configured to control the beam direction and carrier frequency during at least one of a DRX or C-DRX period based on the beam direction and frequency band to monitor based on the at least one of the DRX or C-DRX configurations received from the application processor.

12. The apparatus of claim 1, wherein:
the application processor is configured to, in addition to the estimated wireless link quality, provide to the modem additional information comprising:
the flight path,
an estimation of the orientation and velocity of the drone based on measurements from the sensors, locations and antenna patterns of the serving cell and neighboring cells, and at least one of current or future position of the drone, and
a priority list of beam directions and carrier frequencies, and the modem is configured to:
compute and control the beam direction and the carrier frequency based on the estimated wireless link quality and the additional information.

13. The apparatus of claim 12, wherein:
the modem is configured to, in response to reception of a Radio Resource Control (RRC)Config message or RRCReconfig message that comprises base station information including a new serving cell identification (ID) and timing budget for beam switching to communicate with the new serving cell, provide the base station information to the application processor,
in response to reception of the base station information, the application processor is configured to provide to the modem communication information comprising: position and orientation of the drone and position of the new serving cell, and
in response to reception of the communication information, the modem is further configured to compute and control a new beam direction for communication with the new serving cell based on the communication information before expiration of the timing budget.

14. The apparatus of claim 12, wherein:
the modem is configured to provide to the application processor neighbor cell information comprising: the measurement gap configuration and neighbor cell list and frequency configuration of neighboring cells in the neighbor cell list,
in response to reception of the neighbor cell information, the application processor is configured to provide to the modem communication information comprising: position and orientation of the drone and position of the neighboring cells, and
in response to reception of the communication information, the modem is further configured to compute and control the beam direction and frequency band based on the communication information and the wireless link quality estimate to monitor the neighbor cells during a measurement gap indicated by the measurement gap configuration.

15. The apparatus of claim 12, wherein:
the modem is configured to provide a paging cycle configuration to the application processor,
in response to reception of the paging cycle configuration, the application processor is configured to:
compute the beam direction and frequency band to monitor during the paging cycle based on the flight path, position and orientation of the drone, and position of neighbor cells, and
provide the beam direction and frequency band to the modem, and
the modem is further configured to control the antennas to form the beam to monitor the serving cell during the paging cycle based on the beam direction and frequency band from the application processor.

16. The apparatus of claim 12, wherein:
the modem is configured to provide idle-mode discontinuous reception (DRX) and connected-mode DRX (C-DRX) configurations to the application processor,
in response to reception of the DRX and C-DRX configurations, the application processor is configured to:
compute the beam direction and frequency band to monitor based on the DRX and C-DRX configurations,
provide to the modem the beam direction and frequency band to monitor based on the DRX and C-DRX configurations, and
trigger the modem to perform measurements during reception periods configured by the serving cell based on at least one of the DRX or C-DRX configurations and perform opportunistic measurement during non-reception periods configured by the serving cell based on the at least one of the DRX or C-DRX configurations, and
the modem is further configured to control the beam direction and carrier frequency during at least one of a DRX or C-DRX period based on the beam direction and frequency band to monitor based on the at least one of the DRX or C-DRX configurations received from the application processor.

17. The apparatus of claim 1, wherein:
the computation and control of the beam direction and the carrier frequency by the at least one of the application processor or modem is further based on database information from a wireless environment database provided to the apparatus, the database information comprising past preferred beam directions associated with particular geographical areas.

18. The apparatus of claim 1, wherein the application processor is further configured to:
analyze a wireless environment along the flight path in the near future,
compute a priority neighbor cell scanning list,
determine frequencies to be scanned along the flight path based on the priority neighbor cell scanning list and position of the drone, and
if the computation and control of the beam direction and carrier frequency is to be performed by the modem, provide the frequencies to be scanned along the flight path to the modem.

19. The apparatus of claim 18, wherein the application processor is further configured to:
compute the priority neighbor cell scanning list based on a signal quality estimation from each neighbor cell along the flight path in the priority neighbor cell scanning list to minimize handover among the neighbor cells.

20. The apparatus of claim 1, wherein:
the antennas comprise a directional antenna and an omni-directional antenna, the directional antenna used for data and control communication between the apparatus and the serving cell, and the omni-directional antenna used for cell selection among the serving cell and neighbor cells and handover event triggering.

21. The apparatus of claim 20, wherein:
the modem is configured to determine when to switch between the directional antenna and the omni-directional antenna,
computation of measurement report metrics from measurements of reference signals from the serving cell and neighbor cells comprises filtering the measurements using a layer 1 (L1) filter and an L3 filter prior to evaluation of the measurements, and
a switch to switch between a receiver chain of the directional antenna and a receiver chain of the omni-directional antenna is disposed at one of: prior to the L1 filter, between the L1 filter and the L3 filter, or after the L3 filter.

22. The apparatus of claim 1, wherein:
the application processor is configured to provide an estimation of at least one of a layer 1 (L1) or L3 measurement of a signal from one of the serving cell or a neighboring cell by an omni-directional antenna to the modem, the estimation based on the flight path and information obtained from a network database, and
the modem configured to replace a measurement of the signal by a directional antenna with the estimation.

23. The apparatus of claim 1, wherein:
the antennas comprise a directional antenna configured to receive a signal from one of the serving cell or a neighboring cell,
the one of the application processor or modem is configured to estimate a measurement of the signal, as if received by an omni-directional antenna, after one of layer 1 (L1) or L3 filtering,
the estimation is based on a corresponding measurement of the signal after L1 or L3 filtering, a directional antenna pattern of the directional antenna and a map of the serving cell and neighbor cells, and
the one of the application processor or modem is configured to replace the corresponding measurement of the signal with the estimation.

24. The apparatus of claim 1, wherein:
the antennas comprise a directional antenna configured to receive a signal from one of the serving cell or a neighboring cell,
the one of the application processor or modem is configured to estimate a measurement of the signal, as if received by an omni-directional antenna, after one of layer 3 (L3) filtering,
the estimation is based on a directional measurement of the signal after L1 filtering, a directional antenna pattern of the directional antenna and a map of the serving cell and neighbor cells, and
the one of the application processor or modem is configured to replace a measurement of the signal after L3 filtering with the estimation.

25. The apparatus of claim 1, wherein the one of the application processor or modem is configured to:
control the beam direction based on the location of the drone and locations of device-servicing stations (DSS),
determine whether to switch to a different beam direction for communication with a serving DSS based on velocity of the drone and a change in at least one of the orientation or altitude of the drone, the change in altitude determined based on a change in azimuth and elevation angles, and
when a new DSS is assigned, switch to a different beam direction for communication with the new DSS.

26. The apparatus of claim 25, wherein the one of the application processor or modem is configured to:
in response to detection of the change in at least one of the orientation or altitude of the drone, set a new priority list of beam directions and scan beams based on a beam order in the new priority list of beam directions to find an optimal beam with a signal from the serving DSS having a predetermined signal quality.

27. The apparatus of claim 1, wherein the one of the application processor or modem is configured to:
record, in a log, a sensor measurement that indicates an altitude of the drone when a Minimization of Drive Test (MDT) measurement is taken, the data and control signals comprising an MDT report, and
indicate the altitude of the drone along with the MDT measurement in the MDT report transmitted to the serving cell.

28. The apparatus of claim 27, wherein the one of the application processor or modem is configured to:
record, in the log, a sensor time stamp that indicates when the sensor measurement was taken,
record, in an MDT log, the MDT measurement along with a MDT time stamp that indicates when the MDT measurement was taken, and
combine the MDT measurement with the sensor measurement for transmission in the MDT report based on the sensor and MDT time stamps.

29. The apparatus of claim 27, wherein the one of the application processor or modem is configured to:
determine whether a recording threshold has been met, the recording threshold being at least one of:
a difference between the sensor measurement and an immediately preceding sensor measurement exceeds a first threshold,
the sensor measurement exceeds a second threshold, or
a gradient of sensor measurements exceeds a third threshold, and
in response to a determination that the recording threshold has been met, record the sensor measurement in the log.

30. The apparatus of claim 27, wherein:
the one of the application processor or modem is configured to determine the location of the drone when the MDT measurement is taken,
the location when the MDT measurement is taken is determined when available by sensor measurement and, if sensor measurement is not available, the one of the application processor or modem is configured to estimate from the flight path the location when the MDT measurement is taken, and
record the location when the MDT measurement was taken.

31. The apparatus of claim 27, wherein:
the one of the application processor or modem is configured to use the flight path to estimate the location of the drone, and
take the MDT measurement when the one of the application processor or modem estimates that the drone is in an area of interest.

32. The apparatus of claim 1, wherein the one of the application processor or modem is configured to:
take a Minimization of Drive Test (MDT) measurement even if at least one of the drone is unconnected to a cell in a configured list of cells or in-device coexistence (IDC) is present, the data and control signals comprising an MDT report.

33. The apparatus of claim 1, wherein the one of the application processor or modem is configured to:
take a Minimization of Drive Test (MDT) measurement regardless of network configurations if a predetermined condition is met, the data and control signals comprising an MDT report, the predetermined condition selected from among:
at least one of the drone is unconnected to a network or in-device coexistence (IDC) is present, and
at least one of:
the sensor detects at least one of a change in travel direction or orientation, or
the one of the application processor or modem determines that a predetermined location has been reached.

34. The apparatus of claim 1, wherein:
the one of the application processor or modem is configured to determine a Minimization of Drive Test (MDT) configuration dependent on a plurality of battery levels of the drone, the data and control signals comprising an MDT report, and
the battery levels include a safety power level for safe operation of the drone and a mission power level for the drone to complete a preconfigured mission, the mission power level higher than the safety power level.

35. The apparatus of claim 34, wherein:
if the one of the application processor or modem determines that a current battery life is at most incrementally larger than the safety power level, the one of the application processor or modem is configured to:
either refrain from taking MDT measurements or take MDT measurements having an MDT measurement interval set to a largest available value,
deactivate in-device coexistence (IDC) detection and measurement, Bluetooth measurements, and Wireless Local Area Network (WLAN) measurements, and
continue to measure serving cell and neighbor cell reference signals for mobility purposes.

36. The apparatus of claim 34, wherein:
if the one of the application processor or modem determines that a current battery life is substantially larger than the safety power level but smaller than the mission power level, the one of the application processor or modem is configured to:
select whether to take MDT measurements at an MDT measurement interval set to a medium available value,
refrain from reporting the MDT measurements until completion of the preconfigured mission, and
determine whether take to in-device coexistence (IDC) measurements.

37. An apparatus of a base station, the apparatus comprising:
a transceiver configured to communicate with a drone using a beam formed by antennas and a carrier frequency; and
a processor configured to:
control a direction of the beam based on drone information, the drone information comprising a three-dimensional location, orientation, and flight plan of the drone; and
configure the transceiver to receive a Minimization of Drive Test (MDT) report from the drone based on the drone information and battery life of the drone.

38. The apparatus of claim 37, wherein:
the MDT report comprises an MDT measurement and the flight plan of the drone, and, if a detection threshold is met at the drone, sensor readings of the drone.

39. A non-transitory computer-readable storage medium that stores instructions for execution by one or more processors of a drone, the one or more processors to configure the drone to, when the instructions are executed:
determine drone information that includes a geographic location, including altitude, and an orientation of the drone;
communicate with a serving base station using a directional antenna and use an omni-directional antenna, if present, for cell selection among the serving base station and neighbor base stations;
using the drone information and a flight path of the drone, control beam direction and carrier frequency for data and control communication with the serving base station, for monitoring the neighboring base stations during a measurement gap of the serving base station, for monitoring the serving base station during a paging cycle, and for scanning the neighbor base stations during idle-mode discontinuous reception (DRX) and connected-mode DRX (C-DRX); and
adjust Minimization of Drive Test (MDT) measurement and reporting and in-device coexistence (IDC) measurement using the drone information, the flight path of the drone, and battery life of the drone.

40. The medium of claim 39, wherein the one or more processors further configure the drone to, when the instructions are executed:
if the omni-directional antenna is not present, for cell selection among the serving base station and neighbor base stations, replace directional measurements taken with the directional antenna with estimated measurements, the estimated measurements corresponding to measurements taken as if with the omni-directional antenna,
wherein the estimated measurements are one of:
received from a network database, or
calculated from the directional measurements.
